(19) United States
(12) Patent Application Publication
(10) Pub. No.: US 2022/0301358 A1
(43) Pub. Date: Sep. 22, 2022

(54) BLUETOOTH RACE STARTING TIME SYNCHRONIZATION SYSTEM

(71) Applicant: Nicole Semler, Randolph, NJ (US)

(72) Inventor: Nicole Semler, Randolph, NJ (US)

(21) Appl. No.: 17/203,897

(22) Filed: Mar. 17, 2021

(51) Int. Cl. G07C 1/24; A63B 71/06; H04W 4/80

(52) U.S. Cl. CPC G07C 1/24; A63B 71/0686; H04W 4/80; A63B 2071/0688

(57) ABSTRACT

A semi- to fully-automatic timing system for racing events generates the starting signal(s) of the race, which are synchronized with race timing through Bluetooth Low Energy (BLE) transmissions to cellular-connected devices, such as smartphones. Race results are immediately uploaded by the connected devices to a database, which can be cloud-based, using a racing software app. If necessary, BLE range is extendable through at least one custom relay. Sound and visual starting cues are generated by the starting device and/or with optional amplification by Bluetooth-connected peripherals. The starting device incorporates a transmitter comprising a custom Bluetooth-enabled chip and/or custom printed circuit board. The starting device also has a reset button which triggers a pre-programmed response, including time clock reset, for false starts.

### FIELD OF INVENTION

The present invention relates to the general field of devices used to signal the start of an athletic event, such as a foot race, and more particularly to such devices which utilize Bluetooth technology.

### BACKGROUND OF THE INVENTION

For racing events, there are currently three methods for timing a race—manual, semi-automatic, and fully-automatic. Manual timing requires a starter pistol and stopwatches, and timing records are typically handwritten. Semi- and fully-automatic timing systems use an RF or wireless transmitter in the starting device and an RF receiver on either a timing device and/or computer to capture the race times. The advantage of a semi- and fully-automatic timing systems is the accuracy in the starting of a single race clock, instead of multiple clocks in the manual method. Inaccuracy and variability in recorded times result from the inherent delays from human interaction, but automation increases the cost of the timing system. For many recreational racing events, cost is a major factor in determining the timing method, but accuracy is still desired. With the recent advancements in Bluetooth technology—specifically Bluetooth Low Energy, where range was extended and the number of connected peripherals increased, a starting mechanism can be achieved with benefits similar to an RF or wireless starter, but with the advantage of using electronics that are already readily available—a smartphone, tablet, or computer.

### SUMMARY OF THE INVENTION

The present invention is a semi- or fully-automatic timing system for racing events, in which the starting signal(s) of the race are synchronized with race timing through Bluetooth Low Energy (BLE) transmissions to cellular-connected devices, such as smartphones. Race results are immediately uploaded by the connected devices to a database, which can be cloud-based, using a racing software app. If necessary, BLE range is extendable through one or more custom relays. Sound and visual starting signals are generated by the starting device with optional amplification or by Bluetooth-connected peripherals. The starting device incorporates a transmitter comprising a custom Bluetooth-enabled chip and/or custom printed circuit board. The starting device also has a reset button which triggers a pre-programmed response, including time clock reset, for false starts.

A starting device has four major components—a sound, a visual signal, a trigger, and a power source. A starting device used in semi- or fully-automatic timing must also have a transmitter. For the Bluetooth starting device, the sound is produced through a Bluetooth-connected device or speaker or via an audio output from the starting device connected to an external amplifier. The advantage to using Bluetooth-connected speakers is that multiple speakers can be utilized across a starting line to allow for all racers to hear the sound simultaneously, rather than as sound travels from one side of the starting line to the other. The visual signal can either be from a light connected to the starting device or a strobe from the flash of a Bluetooth-connected peripheral. The trigger can be either a traditional trigger, such as a starting pistol, or a plunger button. The power source comprises batteries that can either be replaceable or rechargeable. Lastly, the transmitter is a Bluetooth-enabled chip on a custom printed circuit board within the device. For the Bluetooth starting device, a reset button can also be added to allow for a pre-programmed response for a false start. For example, instead of having to pull the trigger multiple times to signal a false start like current devices, the audio can be pre-programmed to loop the starting sound or a different sound could be programmed. The reset button would also reset the race clock on Bluetooth-connected peripherals. The starting device can also work in conjunction with one or more relays to improve range, if needed.

Integration of Bluetooth over a RF or wireless solution allows for more integration of other Bluetooth-equipped electronics. This is especially beneficial for recreational sports where cost is a driving factor and many teams still use a fully manual timing system. Being able to leverage functionality of a cellular-connected device like a smartphone within the timing system allows for immediate recording of results directly into a database via a racing software app, thereby increasing efficiency and accuracy.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a front exterior view of a Bluetooth Race Starting Device according to the preferred embodiment of the present invention;

FIG. 2 is a schematic circuitry diagram of the Bluetooth Race Starting Device according to the preferred embodiment of the present invention;

FIG. 3 is a schematic circuitry diagram of a Bluetooth Relay according to the preferred embodiment of the present invention;

FIG. 4 is a schematic diagram of a Bluetooth Race Starting Synchronization System according to the preferred embodiment of the present invention.

### DETAILED DESCRIPTION OF THE PREFERRED EMBODIMENT

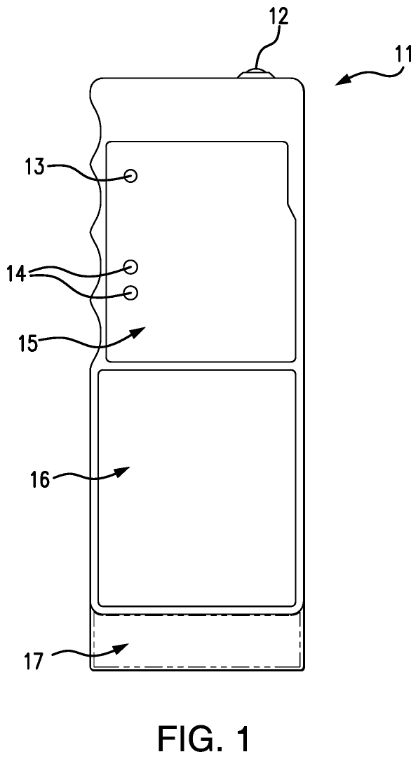

FIG. 1 depicts the front exterior of the race starting device 11 according to the exemplary preferred embodiment of the present invention 10. The hand-held device 11 features a start button 12, which is pushed at the start of a race, and a reset button 13, which resets the race clock on the recording devices 41 in the event of a false start. BLE connection status is indicated by starting status LEDs 14 set in a printed circuit board 15. A starting battery compartment 16 provides electrical power to the device 11, including a light and/or sound starting signal 17.

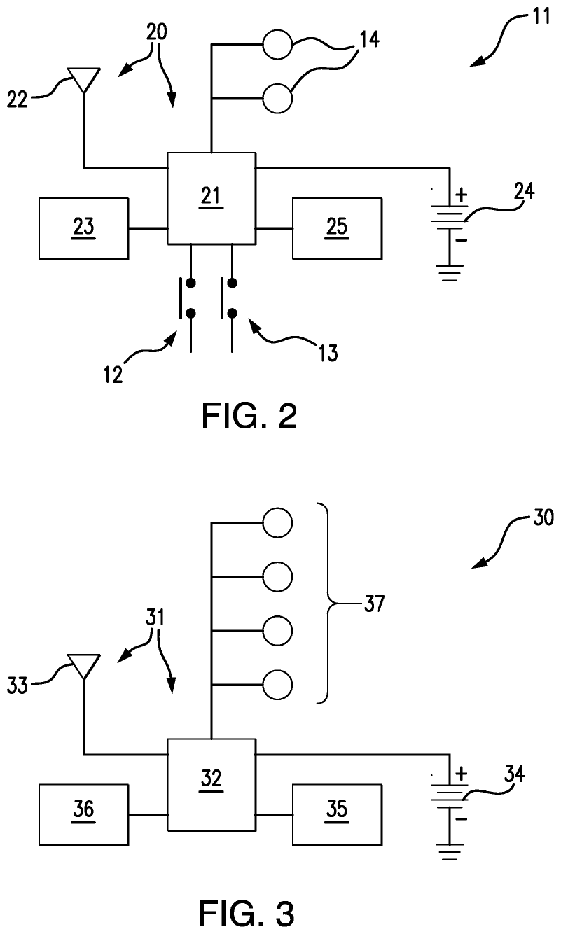

FIG. 2 is a schematic diagram of the circuitry of the exemplary race starting device 11. The BLE transmitter 20 comprises a first BLE chip 21 and a transmitting antenna 22. Electrically connected to the BLE transmitter 20 are the starting signal generating components 23, which generate the light and/or sound signals 17 that signal the start of the race, and the first flash memory 25. A race starting time cue is transmitted by the BLE transmitter 20 to multiple race recording devices 41, as shown in FIG. 4. The race starting device is powered by one or more starting batteries 24, which can be rechargeable.

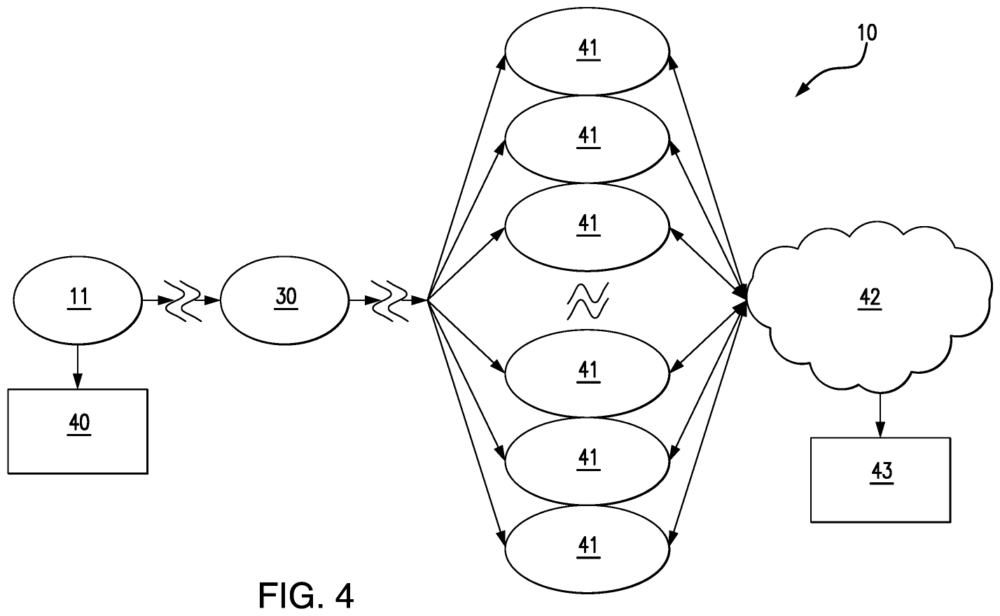

If it is necessary to extend the range of the BLE transmitter 20, at least one BLE relay 30 is interposed between the race starting device 11 and the race recording devices 41, as shown in FIG. 4. A schematic diagram of the circuitry of an exemplary BLE relay 30 is depicted in FIG. 3. Each BLE relay 30 curtains a BLE transceiver 31, which comprises a second BLE chip 32 and a transceiving antenna 33.

Still referring to FIGS. 3 and 4, the race starting time cue transmitted from the BLE transmitter 20 of the race starting device 11 is received by the BLE transceiver 31 of the BLE relay 30 and is re-transmitted by the BLE transceiver 31 to the race recording devices 41. Each of the race recording devices 41 are cellular and/or Wi-Fi connected devices, such as smartphones or tablets. The second BLE chip 32 is part of a second printed circuit board 36 in the BLE relay 30, which is powered by the relay batteries 34. Electrically connected to the BLE transceiver 31 are the relay signal generating components 36 and the second flash memory 35. A series of LEDs 37 indicate the connection status of the second BLE chip 32 to the starting device 11 and the race recording device(s) 41.

Referring again to FIG. 4, each of the race recording devices 41 runs a race application software, which each race recording device 41 uses to calculate a race completion time for each race participant, based on the race starting time cue transmitted from the race starting device 11 and a participant race finish time recorded by the race recording device 41. An example of race application software which can be used by the race recording devices 41 is MeetScoreSheet (www.meetscoresheet.com). Each race recording device 41 then transmits the race completion time to a race results database 43, which can be cloud-based 42.

In addition to the light/sound starting signals generated by the race starting device itself 17, the race starting device can be connected, wired or wirelessly, to one or more peripheral sound/light generating peripherals 40.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A race starting time synchronization system, comprising:
a hand-held race starting device, wherein the race starting device comprises a Bluetooth Low Energy (BLE) transmitter, having a first BLE chip and a transmitting antenna, and wherein the race starting device further comprises at least one starting signal generating component, one or more starting batteries electrically connected to the BLE transmitter and to the starting signal generating component, a start button, a reset button, a first flash memory, and one or more starting BLE status LEDs;
one or more race recording devices, wherein each race recording device is configured to receive BLE transmissions of a race starting time cue from the race starting device, and wherein each race recording device is connected, through a wireless cellular or Wi-Fi network, to a race database, and wherein each race recording device runs a racing application software;
wherein the race starting device is configured, upon the activation of the start button or the reset button, to generate the race starting time cue, and wherein the race starting device is configured to transmit the race starting time cue by the BLE transmitter through the transmitting antenna to each race recording device, and wherein each race recording device is configured to use the racing application software to calculate a race completion time for a race participant, and wherein each race recording device is configured to upload the race completion time to the race database.

2. The system according to claim 1, further comprising at least one BLE relay, wherein each BLE relay comprises a BLE transceiver having a second BLE chip and a transceiving antenna, and wherein the BLE relay further comprises one or more relay batteries electrically connected to the BLE transceiver, a second flash memory, and one or more relay BLE status LEDs, and wherein the BLE relay is configured to receive the BLE transmissions of the race starting time cue from the race starting device, and wherein the BLE relay is configured to transmit the race starting time cue by the BLE transceiver through the transceiving antenna to each race recording device.

3. The system according to claim 1, wherein the starting cue generating component of the race starting device is configured to transmit simultaneously one or more signals, which are audible or visual or both, starting through the BLE transmitter to one or more BLE-enabled peripheral devices, and wherein the peripheral devices are operative to amplify the starting signals.

4. The system according to claim 2, wherein the starting cue generates component of the race starting device is configured to transmit simultaneously one or more starting signals, which are audible or visual or both, through the BLE transmitter to one or more BLE-enabled peripheral devices, and wherein the peripheral devices are operative to amplify the starting signals.

5. The system according to claim 1, wherein the race database is cloud-based.

6. The system according to claim 2, wherein the race database is cloud-based.

7. The system according to claim 3, wherein the race database is cloud-based.

8. The system according to claim 4, wherein the race database is cloud-based.
